(19) United States
(12) Patent Application Publication
(10) Pub. No.: US 2024/0240697 A1
(43) Pub. Date: Jul. 18, 2024

(54) SWIVEL CONNECTION DEVICE

(71) Applicant: CAMP S.P.A., Premana (Lecco) (IT)

(72) Inventors: Antonio CODEGA, Premana (Lecco) (IT); Andrea DONADONI, Premana (Lecco) (IT)

(21) Appl. No.: 18/558,819

(22) PCT Filed: May 19, 2022
(86) PCT No.: PCT/IB2022/054670

§ 371 Date: Nov. 3, 2023

(30) Foreign Application Priority Data
May 19, 2021 (IT) 102021000012905

(51) Int. Cl. F16G 15/08; F16B 45/02; F16G 15/04

(52) U.S. Cl. CPC F16G 15/08; F16B 45/023; F16G 15/04

(57) ABSTRACT

A swivel connection device having a housing body, two coupling elements connected to the housing body, and hinged connection elements connected to the housing body is provided. The two coupling elements are freely rotatable relative to one another about a main rotation axis defined by the hinged connection elements. Each coupling element, in an operating configuration, supports a respective load directed along a respective load direction substantially parallel to the main rotation axis. The housing body defines a plurality of connection seats, and each connection seat defines a stop wall. Each of the two coupling elements is inserted into a respective connection seat, against a respective stop wall, along an insertion direction. The insertion direction of each coupling element is in a direction concordant with the load direction of the load supported by a same coupling element.

The present invention relates to a swivel connection device, especially for the connection of elements subjected to possible rotational loads.

There are known swivel connection devices substantially consisting of one or more closed rings, which are freely rotatable about a central rotation axis.

A type of known swivel connection device comprises two rings being freely rotatable relative to one another about a central rotation axis defined by a central body. The rings comprise a hooked portion and a closing element being screwable to the hooked portion so as to close the ring. A swivel connection device thus configured is described in US 2015/143674 A1, for example.

A further type of known swivel connection device consists of a single non-open ring coupling element, connected to a central body being screwable to a wall or other support structure. A device thus configured is described in U.S. Pat. No. 8,424,638 B1, for example.

A further known swivel connection device, particularly used for lifting loads, is described in document WO 90/10803 and comprises an anchoring unit connected to a base element, for example a platform or a rotatable hook, on which the load to be lifted is placed. This device also comprises a central body, interposed between said anchoring unit and the base element and being rotatable with respect to the anchoring unit, to which, during assembly, a connection element is connected, being rotatable with respect to the central body and forming a ring through which a rope can be passed to lift the load.

Solutions like those described above, although satisfactory under various technical aspects, have several disadvantages. For example, these known devices have a complex assembly, which does not ensure high reliability and safety, as well as having high costs.

It is the object of the present invention to provide a swivel connection device such as to overcome at least some of the drawbacks of the prior art.

It is a particular object of the present invention to provide a swivel connection device that can be quickly and safely assembled.

It is a further particular object of the present invention to provide a swivel connection device with reduced costs and complexity.

These and other objects are achieved by a swivel connection device according to independent claim 1.

The dependent claims relate to preferred and advantageous embodiments of the present invention.

In order to better understand the invention and appreciate the advantages thereof, some non-limiting exemplary embodiments thereof will be described below with reference to the accompanying drawings, in which:

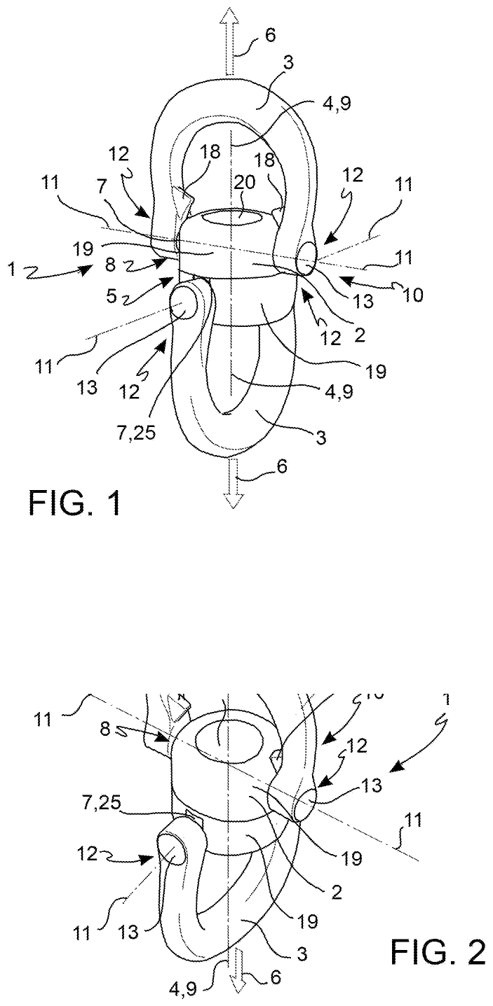

FIG. 1 is a perspective view of a swivel connection device, according to an embodiment of the invention;

FIG. 2 is a top perspective view of the swivel connection device depicted in FIG. 1;

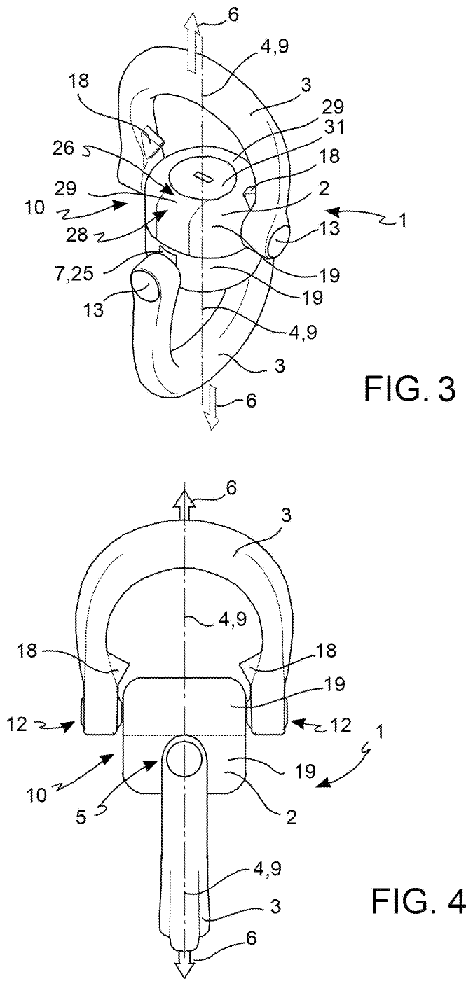

FIG. 3 is a bottom perspective view of the swivel connection device depicted in FIG. 1;

FIG. 4 is a front view of the swivel connection device depicted in FIG. 1;

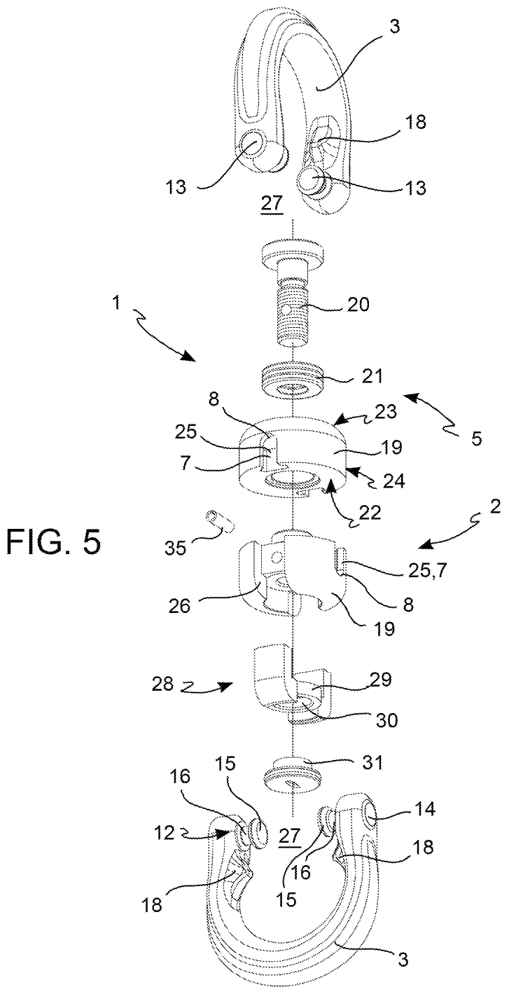

FIG. 5 is an exploded view of a swivel connection device, according to an embodiment of the invention;

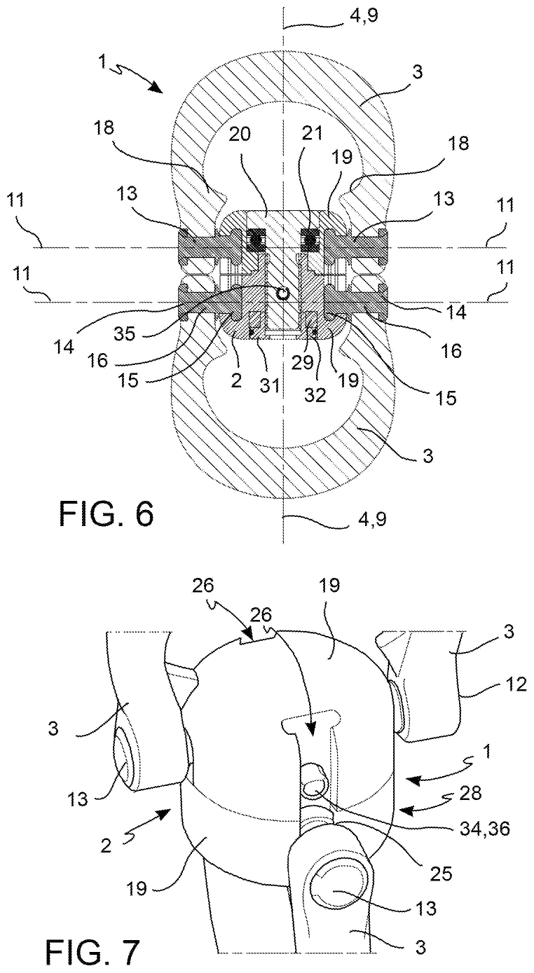

FIG. 6 is a longitudinal section view of a swivel connection device, according to an embodiment of the invention;

FIG. 7 is a detail view of a swivel connection device, according to a further embodiment of the invention;

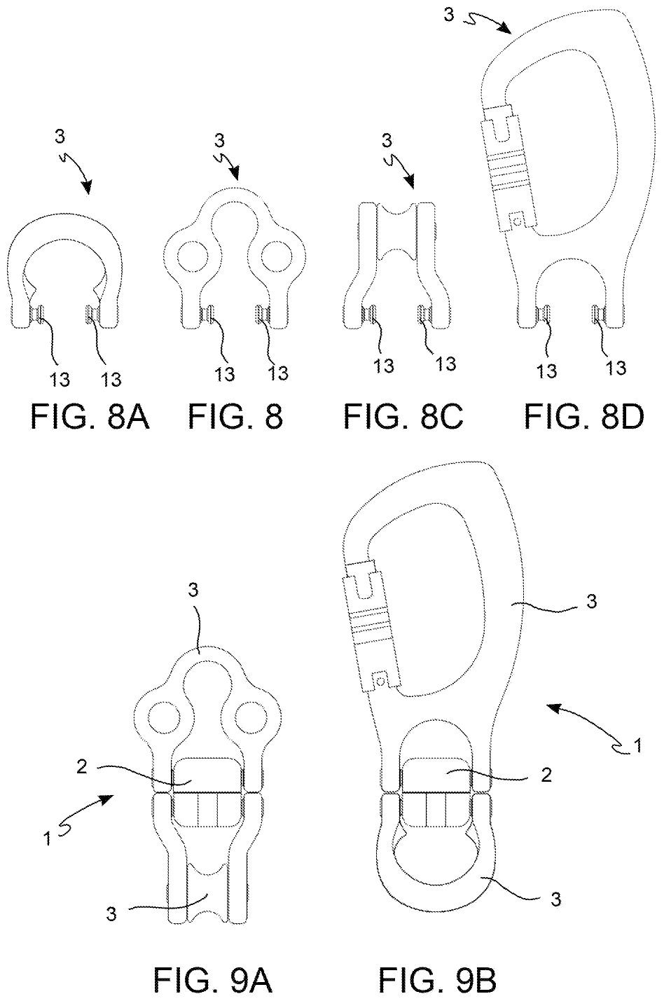

FIGS. 8A, 8B, 8C and 8D are front views of components being connectable to a swivel connection device, according to an embodiment of the invention;

FIGS. 9A and 9B are front section views of a swivel connection device, according to further embodiments.

With reference to the figures, a swivel connection device is generally indicated by reference numeral 1.

The device 1 comprises a housing body 2, two coupling elements 3 connected to the housing body 2, and hinged connection means 5 connected to the housing body 2.

The two coupling elements 3 are freely rotatable relative to one another about a main rotation axis 4 defined by the hinged connection means 5.

Each coupling element 3, in the operating configuration, is configured to support a respective load directed along a respective load direction 6 substantially parallel to the main rotation axis 4.

According to an aspect of the invention, the housing body 2 defines a plurality of connection seats 7, and each connection seat 7 defines a stop wall 8.

Moreover, each of the two coupling elements 3 is inserted into a respective connection seat 7, against the respective stop wall 8, along an insertion direction 9.

Furthermore, such an insertion direction 9 of each coupling element 3 is in a direction concordant with the load direction 6 of the load supported by the same coupling element 3.

Advantageously, the coupling elements 3, in order to be connected to the housing body 2, do not require pins, screws or other components acting as load-bearing elements.

Advantageously, a swivel connection device thus configured can be quickly and safely assembled.

Further advantageously, a swivel connection device thus configured has reduced costs and complexity.

According to an embodiment of the invention, the coupling elements 3 are connected to the housing body 2 by means of a geometric connection 10.

Moreover, the geometric connection 10 is reversible to allow each hook 3 to be disconnected from the housing body 2.

Advantageously, the geometric connection 10 allows safely disassembling and reassembling the device 1, so as to facilitate the connection thereof with bulky or hard-to-move elements.

According to an embodiment, the geometric connection 10 forms an undercut.

### Coupling Elements 3

According to an embodiment of the invention, the coupling elements 3 are freely rotatable relative to one another about a respective further secondary rotation axis 11.

Each secondary rotation axis 11 is defined by the respective connection seat 7, at the stop wall 8.

The coupling elements 3 are freely rotatable relative to one another about the respective secondary rotation axes 11 up to mutual interference.

Advantageously, this further degree of freedom accommodates any further movement of the loads supported by the coupling elements 3, thus reducing the tensions acting on the coupling elements 3.

According to an embodiment, the coupling elements 3 have an open-ring shape, so as to form two ring ends 12 and a connection opening 27 defined between the two ring ends 12.

Each coupling element 3 comprises two pins 13 positioned at the ring ends 12 and extending one towards the other into the coupling element 3.

The pins 13 define a pin foot 14 connected to the ring end 12, a pin head 15 opposite to the pin foot 14 and housed in the connection seat 7 of the housing body 2, and a pin body 16 interposed between the pin foot 14 and the pin head 15.

According to an embodiment, the pin head 15 forms an enlarged cross-section with respect to the pin body 16.

Advantageously, such an enlarged cross-section is suitable for supporting a sudden side load acting on the coupling elements 3, or a sudden load due to an incorrect installation of device 1.

According to an embodiment, the pin 13 is shaped substantially axially symmetrical with respect to an axis parallel to the secondary rotation axis 11.

According to an embodiment, the pin foot 14 is inserted into the ring end 12 and is fixed to the ring end 12 by means of a washer 17. The washer 17 is configured to ensure an increased structural strength of device 1.

According to an embodiment, the pins 13 are made in a single piece with the coupling element 3.

According to a preferred embodiment, the two pins 13 are made of a more resistant material than the material of the coupling element 3.

The pins 13 are preferably made of stainless steel.

According to an embodiment, each coupling element 3 comprises at least one projection 18 extending into the coupling element 3.

Each coupling element 3 preferably comprises two projections 18 opposite to each other.

Advantageously, such projections 18 promote the correct positioning and assembly of the components of device 1 and prevent incorrect assembly operations.

According to an embodiment, the projections are positioned at the housing body 2, so as to embrace the housing body 2.

According to a preferred embodiment, the projections 18 are configured to have a saw-tooth shape.

According to an alternative embodiment, the coupling elements 3 have a pulley shape, a multi-anchor shape, or connector shape, preferably a carabiner (FIGS. 8A-D, FIGS. 9A-B).

### Housing Body 2

According to an embodiment, the housing body 2 comprises two half-shells 19, which are connected to each other by the hinged connection means 5 and freely rotatable relative to one another about the main rotation axis 4.

To each half-shell 19 is connected one of the two coupling elements 3.

According to an embodiment, the hinged connection means 5 comprise an axial bearing 21 inserted into one of the two half-shells 19.

Moreover, the hinged connection means 5 comprise a screw 20 extending along the main rotation axis 4, through the two half-shells 19 and through the axial bearing 21. The head of screw 20 preferably abuts against the axial bearing 21.

Preferably, the axial bearing 21 is of the ball type.

According to an embodiment, a first half-shell 19 of said two half-shells 19 defines two insertion guides 26.

According to this embodiment, by rotating at least one of the two half-shells 19, either the insertion guides 26 or the connection seat 7 made in the first half-shell 19 can be aligned with the connection seat 7 made in the opposite second half-shell 19.

Advantageously, such a configuration allows inserting the first coupling element 3 into the insertion guides 26 of a first half-shell 19, along an insertion direction 9. By an appropriate rotation of at least one of the two half-shells 19, the insertion guides 26 of the first half-shell 19 can be aligned with the connection seat 7 of the opposite second half-shell 19. By further sliding the first coupling element 3 along the insertion guides 26, said first coupling element 3 can be inserted into the connection seat 7 of the opposite second half-shell 19. Once the first coupling element 3 has been inserted into the connection seat 7 of the opposite second half-shell 19, the first coupling element 3 can be positioned to abut against the stop walls 8 of the connection seat 7 of the opposite second half-shell 19. By a further appropriate rotation of at least one of the two half-shells 19, the connection seat 7 of the opposite second half-shell 19 can be aligned with the connection seat 7 of the first half-shell 19. By sliding the first coupling element 3 along the connection seat 7 of the opposite second half-shell 19 along the insertion direction 9 and in the opposite direction with respect to what was done previously, the coupling element 3 can be inserted into the connection seat 7 of the first half-shell 19, so that it abuts against the stop walls 8 of the first half-shell 19. It is now possible to insert the second coupling element 3 into the insertion guides 26 of the first half-shell 19, along the insertion direction 9. By an appropriate rotation of at least one of the two half-shells 19, the insertion guides 26 of the first half-shell 19 can be aligned with the connection seat 7 of the opposite second half-shell 19. By further sliding the second coupling element 3 along the insertion guides 26, said second coupling element 3 can be inserted into the connection seat 7 of the opposite second half-shell 19, respectively. Once the second coupling element 3 has been inserted into the connection seat 7 of the opposite second half-shell 19, the second coupling element 3 can be positioned to abut against the stop walls 8 of the connection seat 7 of the opposite second half-shell 19. The first of the two coupling elements 3 is thus inserted into the respective connection seat 7 of the first half-shell 19. The second of the two coupling elements 3 is inserted instead into the respective connection seat 7 of the second half-shell.

Therefore, in an embodiment, the first half-shell 19 comprises both the insertion guides 26 and the connection seat 7, and the second half-shell 19 comprises only the connection seat 7.

According to an embodiment, each half-shell 19 defines an overlooking wall 22 facing against the opposite half-shell 19, a bottom wall 23 facing away from the opposite half-shell 19, and a peripheral wall 24 interposed between the overlooking wall 22 and the bottom wall 23.

According to an embodiment, each connection seat 7 comprises two connection guides 25.

According to this embodiment, by rotating at least one of the two half-shells 19, either the insertion guides 26 or the connection guides 25 made in the first half-shell 19 can be aligned with the connection guides 25 made in the opposite second half-shell 19.

According to an embodiment, said connection guides 25 are opposite to each other with respect to the main rotation axis 4.

According to an embodiment, the connection guides 25 are hollowed out in the overlooking wall 22 and extend into the half-shell 19. Advantageously, the connection guides 25 extending into the half-shell 19, at their end, define the two stop walls 8 of the connection seat 7.

Moreover according to an embodiment, the connection guides 25 are open at the peripheral wall 24.

Advantageously, such a configuration allows inserting the pin heads 15 of the coupling element 3 into the connection guides 25 of a half-shell 19, through the overlooking wall 22. The pin heads 15 thus inserted can be positioned, by sliding them along the connection guides 25, so as to abut against the stop walls 8. According to an embodiment, the connection guides 25 are shaped so as to form an undercut connection with the pin heads 15 of the coupling element 3.

In detail, the connection guides 25 have a cross section such that the pin heads 15 and the pin bodies 16 of the coupling element 3 are insertable into the connection guides 25 of the half-shells 19 only along the insertion direction 9.

In greater detail and in accordance with the embodiment in which the pin head 15 forms an enlarged cross section with respect to the pin body 16, each connection guide 25 comprises a first portion and a second portion, where the first portion has a cross section of greater width than that of the second portion (not shown in the figure). The pin heads 15 are thus insertable along the insertion direction 9 into the first portion with a cross-section of greater width. The pin body 16 will be insertable instead along the insertion direction 9 into the second portion with a smaller cross-section.

Advantageously, even in the presence of a side load acting on one of the coupling elements 3 in a direction not concordant with direction 9, the load is withstood and the pin heads 15 are prevented from coming out of the connection guides 25 along a direction not concordant with the insertion direction 9.

According to an embodiment, the insertion guides 26 defined in one of the two half-shells 19 are opposite to each other with respect to the main rotation axis 4.

According to an embodiment, the insertion guides 26 are hollowed out in the bottom wall 23 and extend into the half-shell 19, opening out in the overlooking wall 22.

According to an embodiment, the insertion guides 26 are open at the peripheral wall 24.

Advantageously, such a configuration allows inserting the pin heads 15 of the first coupling element 3 into the insertion guides 26 of a first half-shell 19 through the bottom wall 23 of said first half-shell 19, along an insertion direction 9. By an appropriate rotation of at least one of the two half-shells, the insertion guides 26 of the first half-shell 19 can be aligned with the connection guides 25 of the opposite second half-shell 19. By further sliding the pin heads 15 of the first coupling element 3 along the insertion guides 26, the pin heads 15 of said first coupling element 3 can be inserted into the connection guides 25 of the opposite second half-shell 19 (as described above with reference to each connection guide 25, which comprises a first portion and a second portion, where the first portion has a cross-section of greater width compared to the one of the second portion). Once the pin heads 15 have been inserted into the connection guides 25 of the opposite second half-shell 19, the pin heads 15 can be positioned to abut against the stop walls 8 of the connection guides 25 of the opposite second half-shell 19. By a further appropriate rotation of at least one of the two half-shells 19, the connection guides 25 of the opposite second half-shell 19 can be aligned with the connection guides 25 of the first half-shell 19. By sliding the pin heads 15 of the first coupling element 3 along the connection guides 25 along the insertion direction 9 and in the opposite direction with respect to what was done previously, the pin heads 15 of said first coupling element 3 can be inserted into the connection guides 25 of the first half-shell 19 so as to abut against the stop walls 8 of the first half-shell 19. It is now possible to insert the pin heads 15 of the second coupling element 3 into the insertion guides 26 of the first half-shell 19 through the overlooking wall 22, along the insertion direction 9. By an appropriate rotation of at least one of the two half-shells, the insertion guides 26 of the first half-shell 19 can be aligned with the connection guides 25 of the second half-shell 19. By further sliding the pin heads 15 of the second coupling element 3 along the insertion guides 26, the pin heads 15 of said second coupling element 3 can be inserted into the connection guides 25 of the opposite second half-shell 19, through the overlooking wall 22. Once the pin heads 15 have been inserted into the connection guides 25 of the opposite second half-shell 19, the pin heads 15 can be positioned to abut against the stop walls 8 of the same connection guides 25. The pin heads 15 of the first of the two coupling elements 3 connected to the housing body 2 are thus positioned in the connection guides 25 of the first half-shell 19. The pin heads 15 of the second of the two coupling elements 3 are positioned instead in the connection guides 25 of the opposite second half-shell 19.

According to a preferred embodiment, the insertion guides 26 are formed on the half-shell 19 opposite to the half-shell 19 in which the axial bearing 21 is installed.

Advantageously, such a configuration reduces the overall dimensions and complexity of device 1.

According to an embodiment, the insertion guides 26 are orthogonal to the connection guides 25, with reference to the main rotation axis 4.

According to an embodiment, the device 1 comprises locking means 28 configured to prevent the disassembly of the coupling elements 3 from the housing body 2.

According to an embodiment, the locking means 28 comprise a cap 29 conveniently shaped to be inserted into the insertion guides 26 and prevent the coupling elements 3 from coming out of the insertion guides 26.

According to an embodiment, the cap 29 is made in a single piece and is insertable into the insertion guides 26 through the bottom wall 23 of the half-shell 19.

According to an embodiment, the cap 29 is made of a metal material and is fixed, by interference, in the insertion guides 26.

According to an embodiment, the cap 29 forms a central hole 30 adapted to be crossed by screw 20.

According to an embodiment, the device 1 comprises a closing nut screw 31.

The closing nut screw 31 is screwable to the screw 20, so as to abut against the cap 29 and prevent the cap 29 from coming out of the insertion guides 26.

The closing nut screw 31 forms a nut screw head 33 shaped so as to allow screwing the closing nut screw 31 to screw 20.

According to an embodiment, the closing nut screw 31 comprises a gasket 32, e.g., an O-ring, positioned at the nut screw head 33, and adapted to improve the sealing action of the closing nut screw 31.

Advantageously, the cap 29 and the closing nut screw 31 do not work as load-bearing elements, and therefore are not linked to the structural strength of device 1.

Further advantageously, the device 1 thus configured requires the manual operation of only the closing nut screw 31 for the insertion and extraction of both the coupling elements 3 and for the very same closing and opening of the device 1 itself.

According to an alternative embodiment, the locking means 28 comprise snap-closing means, e.g., spring buttons 34, positioned at the insertion guides 26.

The spring buttons 34 comprise buttons 36 being retractable into the housing body 2, and compression springs 35, housed in the housing body 2, and configured to stress the buttons 36 coming out of the housing body 2.

Advantageously, the device 1 thus configured does not require the manual operation of any screw or other threaded element for the insertion and extraction of both the coupling elements 3 and for the very same closing and opening of the device 1 itself.

Obviously, those skilled in the art will be able to make changes or adaptations to the present invention without departing from the scope of the claims set forth below.

1. A swivel connection device, comprising:
a housing body;
two coupling elements connected to the housing body;
hinged connection means connected to the housing body;
wherein the two coupling elements are freely rotatable relative to one another about a main rotation axis defined by the hinged connection means,
wherein each coupling element, in an operating configuration, is configured to support a respective load directed along a respective load direction substantially parallel to the main rotation axis,
wherein the housing body defines a plurality of connection seats, and each connection seat of said plurality of connection seats defines a stop wall,
wherein each of the two coupling elements is inserted into a respective connection seat, against a respective stop wall, along an insertion direction,
and wherein said insertion direction of each coupling element is in a direction concordant with the load direction of the load supported by a same coupling element.

2. The swivel connection device of claim 1, wherein the two coupling elements are connected to the housing body by means of a geometric connection, and wherein said geometric connection is reversible to allow each coupling element to be disconnected from the housing body.

3. The swivel connection device of claim 2, wherein the geometric connection forms an undercut.

4. The swivel connection device of claim 1, wherein the two coupling elements are freely rotatable relative to one another about a respective secondary rotation axis, and wherein each secondary rotation axis is defined by the respective connection seat, at the stop wall.

5. The swivel connection device of claim 1, wherein the two coupling elements have an open-ring shape, so as to form two ring ends and a connection opening defined between the two ring ends, or the two coupling elements have a pulley, multi-anchor, or connector shape.

6. The swivel connection device of claim 5, wherein each coupling element comprises two pins positioned at the ring ends, and extending one towards the other into the coupling element, wherein the pins each define a pin foot connected to a ring end, a pin head opposite to the pin foot and housed in the connection seat of the housing body, and a pin body interposed between the pin foot and the pin head, and optionally, wherein:
the pin head forms an enlarged cross-section with respect to the pin body, and/or
the pin foot is inserted into the ring end, and fixed to the ring end by a washer, and/or
the two pins are made of a more resistant material than a material of the two coupling elements.

7. The swivel connection device of claim 1, wherein each coupling element comprises at least one projection extending into the coupling element.

8. The swivel connection device of claim 7, wherein each coupling element comprises two projections opposite to each other, and wherein the projections are positioned at the housing body, so as to embrace the housing body, and, optionally, the projections have a saw-tooth shape.

9. The swivel connection device of claim 1, wherein the housing body comprises two half-shells, connected to each other by the hinged connection means, said two half-shells being freely rotatable relative to one another about the main rotation axis, wherein to each half-shell is connected one of the two coupling elements, and optionally, wherein:
the hinged connection means comprise an axial bearing inserted into one of the two half-shells, and/or
the hinged connection means comprise a screw extending along the main rotation axis, through the two half-shells and through the axial bearing.

10. The swivel connection device according to of claim 9, wherein a first half-shell of the two half-shells defines two insertion guides, and wherein, by rotating at least one of the two half-shells, either the insertion guides or the connection seat made in the first half-shell can be aligned with the connection seat made on an opposite second half-shell of the two half-shells.

11. The swivel connection device of claim 10, wherein each connection seat comprises two connection guides, and wherein, by rotating at least one of the two half-shells, either the insertion guides or the connection guides made in the first half-shell can be aligned with the connection guides made on the opposite second half-shell.

12. The swivel connection device of claim 11, wherein each half-shell defines an overlooking wall facing against the opposite half-shell, a bottom wall facing away from the opposite half-shell, and a peripheral wall interposed between the overlooking wall and the bottom wall,
wherein the connection guides are opposite to each other with respect to the main rotation axis,
wherein the connection guides are hollowed out in the overlooking wall, and extend into the half-shell,
and wherein the connection guides are open at the peripheral wall.

13. The swivel connection of claim 12, wherein the two coupling elements have an open-ring shape, so as to form two ring ends and a connection opening defined between the two ring ends, or the two coupling elements have a pulley, multi-anchor, or connector shape, wherein each coupling element comprises two pins positioned at the ring ends and extending one towards the other into the coupling element, wherein the pins each define a pin foot connected to a ring end, a pin head opposite to the pin foot and housed in the connection seat of the housing body, and a pin body interposed between the pin foot and the pin head, and, optionally, wherein:
the pin head forms an enlarged cross-section with respect to the pin body, and/or
the pin foot is inserted into the ring end and fixed to the ring end by a washer, and/or
the two pins are made of a more resistant material than a material of the two coupling elements, and wherein
the connection guides are shaped so as to form an undercut connection with the pin heads of the coupling element.

14. The swivel connection device of claim 12, wherein the insertion guides defined in the first half-shell are opposite to each other with respect to the main rotation axis, wherein the insertion guides are hollowed out in the bottom wall and extend into the half-shell, opening out in the overlooking wall, and wherein the insertion guides are open at the peripheral wall.

15. The swivel connection device of claim 10, wherein the insertion guides are formed on the half-shell opposite to the half-shell in which the axial bearing is installed.

16. The swivel connection device of claim 11, wherein the insertion guides are orthogonal to the connection guides, with reference to the main rotation axis.

17. The swivel connection device of claim 1, further comprising locking means configured to prevent a disassembly of the two coupling elements from the housing body.

18. The swivel connection device of claim 12, wherein the swivel connection device further comprises locking means configured to prevent a disassembly of the two coupling elements from the housing body, wherein the locking means comprise a cap conveniently shaped to be inserted into the insertion guides, and prevent the two coupling elements from coming out of the insertion guides, and optionally, wherein the cap is made in a single piece and is insertable into the insertion guides through the bottom wall of the half-shell, and/or the cap is made of a metal material and is fixed, by interference, in the insertion guides.

19. The swivel connection device of claim 18, wherein the cap forms a central hole adapted to be crossed by the screw, the swivel connection device further comprising a closing nut screw, wherein the closing nut screw is screwable to the screw, so as to abut against the cap and prevent the cap from coming out of the insertion guides, and wherein the closing nut screw forms a nut screw head shaped so as to allow the closing nut screw to be screwed to the screw.

20. The swivel connection device of claim 10, wherein the swivel connection device further comprises locking means configured to prevent a disassembly of the two coupling elements from the housing body, wherein the locking means comprise snap-closing means, and optionally, the snap-closing means comprise spring buttons positioned at the insertion guides, and wherein the spring buttons comprise buttons retractable into the housing body and compression springs housed in the housing body and configured to stress the buttons coming out of the housing body.
